(19) United States
(12) Patent Application Publication
(10) Pub. No.: US 2020/0284633 A1
(43) Pub. Date: Sep. 10, 2020

(54) FLUID SENSOR

(71) Applicant: MINEBEA MITSUMI Inc., Nagano (JP)

(72) Inventors: Noriyuki AKIYAMA, Tokyo (JP); Yota YAMAMOTO, Tokyo (JP)

(21) Appl. No.: 16/805,986

(22) Filed: Mar. 2, 2020

(30) Foreign Application Priority Data
Mar. 4, 2019 (JP) 2019-038261

(51) Int. Cl. G01F 1/69

(52) U.S. Cl. CPC G01F 1/69

(57) ABSTRACT

A fluid sensor includes a primary heating resistor, a pair of X-axis temperature detectors disposed to face each other in an X-axis direction across the primary heating resistor, a pair of Y-axis temperature detectors disposed to face each other in a Y-axis direction across the primary heating resistor, and a secondary heating resistor connected to the primary heating resistor and disposed between one of the X-axis temperature detectors and one of the Y-axis temperature detectors.

### CROSS-REFERENCE TO RELATED APPLICATION

The present application is based upon and claims priority to Japanese Patent Application No. 2019-038261, filed on Mar. 4, 2019, the entire contents of which are incorporated herein by reference.

### BACKGROUND OF THE INVENTION

### 1. Field of the Invention

An aspect of this disclosure relates to a fluid sensor.

### 2. Description of the Related Art

There are known fluid sensors for detecting the flow of a fluid such as air. A thermal fluid sensor is an example of such a fluid sensor. An example of a thermal fluid sensor is a microelectromechanical system (MEMS) fluid sensor.

A MEMS fluid sensor is formed by providing a heater in the middle of a membrane (thin film structure) formed in a sensor chip, and placing temperature detectors (resistors) in positions upstream and downstream of the heater. When a fluid to be detected flows over the membrane, a temperature difference corresponding to the flow of the fluid is generated between the upstream side and the downstream side of the heater. This temperature difference is detected by the two temperature detectors placed on the upstream side and the downstream side to detect the flow of the fluid.

In such a fluid sensor, the temperature distribution of heat generated by the heater is preferably symmetrical about the heater when no fluid is flowing. For this reason, various heater shapes suitable to achieve uniform temperature distribution have been proposed (see, for example, Japanese Patent No. 3687724 and Japanese Patent No. 3461469).

Japanese Laid-Open Patent Publication No. 2017-067643 discloses a fluid sensor where a pair of temperature detectors (resistors) are arranged in each of the X-axis direction and the Y-axis direction with respect to a heater to detect the direction (flow direction) of a fluid. This configuration makes it possible to detect the flow direction and the flow rate of a fluid by detecting the flow of the fluid in the X-axis direction and the Y-axis direction.

The fluid sensor described in Japanese Laid-Open Patent Publication No. 2017-067643 may be configured such that the temperature distribution of heat generated by the heater has a circular shape around the heater and becomes uniform. However, when the temperature detectors are arranged along the X axis and the Y axis with respect to the heater to have a temperature distribution with a circular shape as described above, compared with a case where a fluid flows along the X axis or the Y axis, the detection sensitivity of the temperature detectors becomes lower when the fluid flows in a direction other than the X-axis and Y-axis directions.

Thus, the detection accuracy of the flow direction and the flow rate by the fluid sensor described in Japanese Laid-Open Patent Publication No. 2017-067643 needs to be improved.

### SUMMARY OF THE INVENTION

In an aspect of this disclosure, there is provided a fluid sensor that includes a primary heating resistor, a pair of X-axis temperature detectors disposed to face each other in an X-axis direction across the primary heating resistor, a pair of Y-axis temperature detectors disposed to face each other in a Y-axis direction across the primary heating resistor, and a secondary heating resistor connected to the primary heating resistor and disposed between one of the X-axis temperature detectors and one of the Y-axis temperature detectors.

### BRIEF DESCRIPTION OF THE DRAWINGS

FIG. 1 is a plan view exemplifying a structure of a fluid sensor according to a first embodiment;

FIG. 2 is a cross-sectional view taken along line A-A in FIG. 1;

FIG. 3 is an enlarged view of a portion around a heating resistor;

FIG. 4 is a drawing illustrating an example of a temperature distribution when a flow rate is zero;

FIG. 5 is a drawing illustrating an example where a related-art temperature distribution changes depending on the flow of a fluid;

FIG. 6 is a drawing illustrating an example where a temperature distribution according to an embodiment changes depending on the flow of a fluid;

FIG. 7A is a graph illustrating a relationship between a first sensor output signal and a second sensor output signal in a related-art example;

FIG. 7B is a graph illustrating a relationship between a first sensor output signal and a second sensor output signal according to an embodiment;

FIG. 8 is a plan view exemplifying a structure of a fluid sensor according to a first variation;

FIG. 9 is an enlarged view of a portion around a heating resistor of a fluid sensor according to a second variation;

FIG. 10 is an enlarged view of a heating resistor of a fluid sensor according to a third variation;

FIG. 11 is a plan view exemplifying a structure of a fluid sensor according to a fourth variation;

FIG. 12 is an enlarged view of a portion around a heating resistor of a fluid sensor according to the fourth variation; and

FIG. 13 is a graph illustrating a temperature characteristic of a resistance temperature coefficient of vanadium oxide.

### DESCRIPTION OF THE PREFERRED EMBODIMENTS

Embodiments of the present invention are described below with reference to the accompanying drawings. Throughout the accompanying drawings, the same reference number is assigned to the same component, and repeated descriptions of the same component may be omitted.

### First Embodiment

### [Structure of Fluid Sensor]

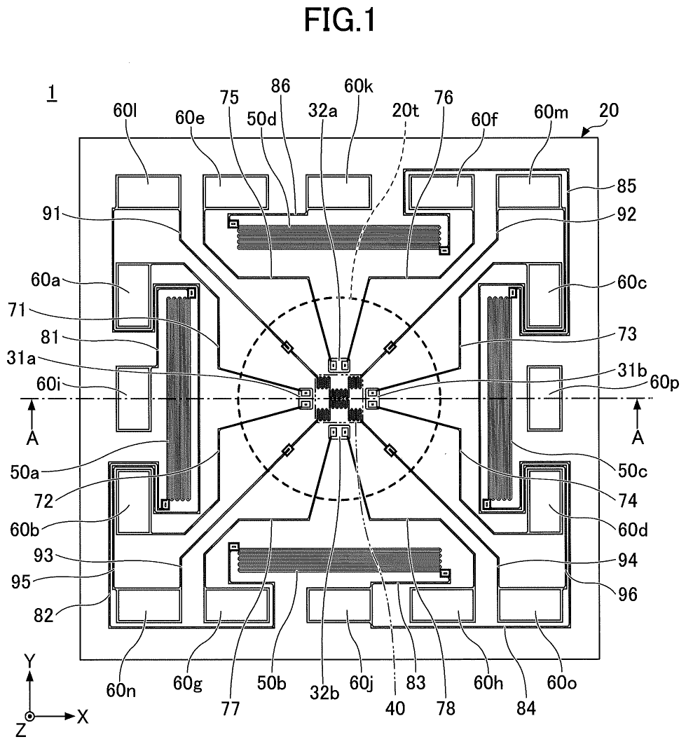

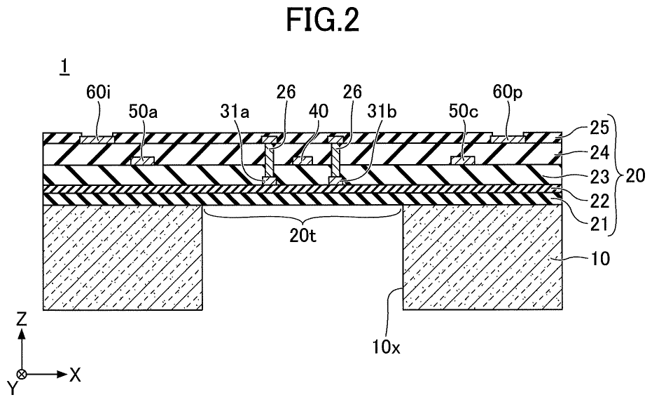

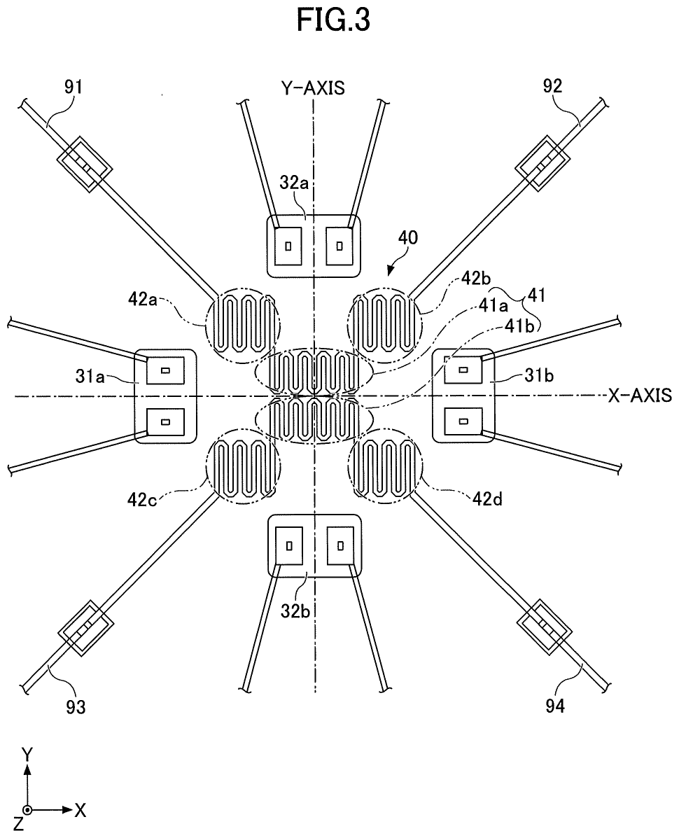

FIG. 1 is a plan view exemplifying a structure of a fluid sensor 1 according to a first embodiment. FIG. 2 is a cross-sectional view taken along line A-A in FIG. 1. FIG. 3 is an enlarged view of a portion around a heating resistor 40.

The fluid sensor 1 includes a semiconductor substrate 10, a multilayer structure 20, X-axis temperature detectors 31a and 31b, Y-axis temperature detectors 32a and 32b, the heating resistor 40, fixed resistors 50a-50d, and bonding pads (which are hereafter referred to as “pads”) 60a-60p.

In FIGS. 1 through 3, axes parallel to two orthogonal sides of the multilayer structure 20 are referred to as an X axis and a Y axis, and the thickness direction of the multilayer structure 20 orthogonal to the X axis and the Y axis is referred to as a Z axis.

As illustrated in FIG. 2, the semiconductor substrate 10 is a frame-shaped silicon substrate including an opening 10x. The multilayer structure 20 has a structure formed by stacking multiple insulating films 21-25, and is disposed on the semiconductor substrate 10 to close the opening 10x. The multilayer structure 20 has, for example, a circular shape in plan view. A region of the multilayer structure 20 above the opening 10x is referred to as a membrane (thin film structure) 20t. The multilayer structure 20 has a thickness of about 0.5 to about 5 μm.

The membrane 20t has, for example, a square shape in plan view. Because the membrane 20t is not in contact with the semiconductor substrate 10, the heat capacity of the membrane 20t is small, and the temperature of the membrane 20t tends to increase. The upper surface of the membrane 20t is a detection surface for detecting the flow of a fluid that is a detection target.

The multilayer structure 20 includes the X-axis temperature detectors 31a and 31b, the Y-axis temperature detectors 32a and 32b, the heating resistor 40, and the fixed resistors 50a-50d. Also, pads 60a-60p are provided on the multilayer structure 20.

The opening 10x is a cylindrical cavity formed by, for example, dry-etching the semiconductor substrate 10. The insulating film 21 is comprised of, for example, a silicon dioxide film (SiO₂), and is formed on the semiconductor substrate 10. The insulating film 21 is formed by, for example, a thermal oxidation method or a chemical vapor deposition (CVD) method. The insulating film 22 comprised of, for example, a silicon nitride film (SiN) is formed on the insulating film 21. The insulating film 22 is formed by, for example, a thermal CVD method.

On the insulating film 22, the X-axis temperature detectors 31a and 31b and the Y-axis temperature detectors 32a and 32b comprised of, for example, vanadium oxide (VO₂) are formed. The X-axis temperature detectors 31a and 31b and the Y-axis temperature detectors 32a and 32b are formed by, for example, a sol-gel method.

The insulating film 23 comprised of, for example, a silicon dioxide film (SiO₂) is formed on the insulating film 22 to cover the X-axis temperature detectors 31a and 31b and the Y-axis temperature detectors 32a and 32b. The insulating film 23 is formed by, for example, a sputtering method or a plasma CVD method.

On the insulating film 23, the heating resistor 40 and the fixed resistors 50a-50d, which are comprised of, for example, platinum (Pt), nichrome (NiCr), or polysilicon, are formed. The heating resistor 40 and the fixed resistors 50a-50d are formed by, for example, a sputtering method.

The insulating film 24 comprised of, for example, a silicon dioxide film (SiO₂) is formed on the insulating film 23 to cover the heating resistor 40 and the fixed resistors 50a-50d. The insulating film 24 is formed by, for example, a sputtering method or a plasma CVD method.

The pads 60a-60p comprised of, for example, aluminum (Al) or gold (Au) are formed on the insulating film 24. The pads 60a-60p are formed by, for example, a sputtering method. Also, in addition to the pads 60a to 60p, wiring is formed on the insulating film 24.

On the insulating film 24, the insulating film 25 comprised of, for example, a silicon nitride film (SiN) is formed so as to cover the wiring and expose at least parts of the upper surfaces of the pads 60a-60p. The insulating film 25 is formed by, for example, a low-temperature CVD method.

Contact plugs 26 for connecting the X-axis temperature detectors 31a and 31b and the Y-axis temperature detectors 32a and 32b to the wiring are formed in the insulating film 23 and the insulating film 24. The contact plugs 26 are formed by filling contact holes in the insulating films 23 and 24 with a conductive material such as tungsten. The contact holes are formed by, for example, wet etching using buffered hydrofluoric acid (BHF). Here, because gaps exist in parts of vanadium oxide forming the X-axis temperature detectors 31a and 31b and the Y-axis temperature detectors 32a and 32b, buffered hydrofluoric acid may penetrate into a lower layer below the vanadium oxide during wet etching. To prevent the lower layer from being etched, the insulating film 22, which is the lower layer below the X-axis temperature detectors 31a and 31b and the Y-axis temperature detectors 32a and 32b, is preferably formed of silicon nitride (SiN) that has a high resistance to buffered hydrofluoric acid.

As illustrated in FIG. 1, the heating resistor 40 is formed in the center of the membrane 20t. The X-axis temperature detectors 31a and 31b are disposed to face each other in the X-axis direction across the heating resistor 40. The Y-axis temperature detectors 32a and 32b are disposed to face each other in the Y-axis direction across the heating resistor 40. The X-axis temperature detectors 31a and 31b detect a temperature difference in the X-axis direction based on a difference in resistance values. The Y-axis temperature detectors 32a and 32b detect a temperature difference in the Y-axis direction based on a difference in resistance values.

The X-axis temperature detector 31a is connected to the pad 60a via a wire 71 and connected to the pad 60b via a wire 72. The X-axis temperature detector 31b is connected to the pad 60c via a wire 73 and connected to the pad 60d via a wire 74. The Y-axis temperature detector 32a is connected to the pad 60e via a wire 75 and connected to the pad 60f via a wire 76. The Y-axis temperature detector 32b is connected to the pad 60g via a wire 77 and connected to the pad 60h via a wire 78.

Each of the fixed resistors 50a-50d is a resistor with a meander structure that is formed by bending a straight line multiple times. The meander structure is employed to increase the resistance value. One end of the fixed resistor 50a is connected to the pad 60i via a wire 81, and another end of the fixed resistor 50a is connected to one end of the fixed resistor 50b via a wire 82. Another end of the fixed resistor 50b is connected to the pad 60j via a wire 83.

One end of the fixed resistor 50c is connected to the pad 60j via a wire 84, and another end of the fixed resistor 50c is connected to one end of the fixed resistor 50d via a wire 85. Another end of the fixed resistor 50d is connected to the pad 60k via a wire 86.

The fixed resistors 50a-50d form a bridge circuit together with the X-axis temperature detectors 31a and 31b and the Y-axis temperature detectors 32a and 32b. The temperature distribution of heat generated by the heating resistor 40 can be detected using this bridge circuit.

For example, a power supply voltage is applied to one of the pad 60i and the pad 60k, and the other one of the pad 60i and the pad 60k is set at the ground potential to use a potential appearing at the pad 60j as a reference potential. Also, the pad 60a and the pad 60c are connected to each other via external wiring, a power supply voltage is applied to one of the pad 60b and the pad 60d, and another one of the pad 60b and the pad 60d is set at the ground potential. In this case, a first sensor output signal is obtained by detecting a difference between the potential appearing at the pad 60a and the pad 60c and the reference potential with a sensor amplifier. The first sensor output signal is a signal corresponding to the temperature difference between the X-axis temperature detectors 31a and 31b, and becomes substantially zero when there is no temperature difference.

Further, the pad 60e and the pad 60g are connected to each other via external wiring, a power supply voltage is applied to one of the pad 60f and the pad 60h, and another one of the pad 60f and the pad 60h is set at the ground potential. In this case, a second sensor output signal corresponding to the temperature distribution in the Y direction is obtained by detecting a difference between the potential appearing at the pad 60e and the pad 60g and the reference potential with a sensor amplifier. The second sensor output signal is a signal corresponding to the temperature difference between the Y-axis temperature detectors 32a and 32b, and becomes substantially zero when there is no temperature difference.

As illustrated in FIG. 3, the heating resistor 40 includes one primary heating resistor 41 and four secondary heating resistors 42a-42d. The primary heating resistor 41 is disposed in the center of the membrane 20t. In the present embodiment, the primary heating resistor 41 is separated into a first heating resistor 41a and a second heating resistor 41b. Each of the first heating resistor 41a and the second heating resistor 41b has a meander structure. When the X axis and the Y axis are defined to intersect at the center of the membrane 20t, the first heating resistor 41a and the second heating resistor 41b are symmetrical with respect to the X axis.

Each of the secondary heating resistors 42a-42d is disposed apart from the intersection between the X axis and the Y axis in a direction that forms an angle of 45 degrees with each of the X axis and the Y axis. Each of the secondary heating resistors 42a-42d has a meander structure formed by bending an extension of a wire of the primary heating resistor 41 multiple times.

The secondary heating resistor 42a is connected to one end of the first heating resistor 41a. The secondary heating resistor 42b is connected to another end of the first heating resistor 41a. That is, the first heating resistor 41a, the secondary heating resistor 42a, and the secondary heating resistor 42b are formed by bending parts of one wire into meander shapes. The secondary heating resistor 42a is substantially disposed between the X-axis temperature detector 31a and the Y-axis temperature detector 32a. The secondary heating resistor 42b is substantially disposed between the Y-axis temperature detector 32a and the X-axis temperature detector 31b. The secondary heating resistor 42a and the secondary heating resistor 42b are symmetrical with respect to the Y axis.

The secondary heating resistor 42c is connected to one end of the second heating resistor 41b. The secondary heating resistor 42d is connected to another end of the second heating resistor 41b. That is, the second heating resistor 41b, the secondary heating resistor 42c, and the secondary heating resistor 42d are formed by bending parts of one wire into meander shapes. The secondary heating resistor 42c is substantially disposed between the X-axis temperature detector 31a and the Y-axis temperature detector 32b. The secondary heating resistor 42d is substantially disposed between the Y-axis temperature detector 32b and the X-axis temperature detector 31b. The secondary heating resistor 42c and the secondary heating resistor 42d are substantially symmetrical with respect to the Y axis.

Also, the secondary heating resistor 42a and the secondary heating resistor 42c are symmetrical with respect to the X axis. Further, the secondary heating resistor 42b and the secondary heating resistor 42d are symmetrical with respect to the X axis.

An end of the secondary heating resistor 42a, which is located opposite the first heating resistor 41a, is connected to the pad 601 via a wire 91. An end of the secondary heating resistor 42b, which is located opposite the first heating resistor 41a, is connected to the pad 60m via a wire 92.

An end of the secondary heating resistor 42c, which is located opposite the second heating resistor 41b, is connected to the pad 60n via a wire 93. An end of the secondary heating resistor 42d, which is located opposite the second heating resistor 41b, is connected to the pad 60o via a wire 94.

The pad 601 and the pad 60n are connected to each other via a wire 95. Also, the pad 60m and the pad 60o are connected to each other via a wire 96. Here, the pad 60p is a dummy pad.

By applying a potential difference between the pads 601 and 60n and the pads 60m and 60o, an electric current flows through a path connecting the first heating resistor 41a, the secondary heating resistor 42a, and the secondary heating resistor 42b, and through a path connecting the second heating resistor 41b, the secondary heating resistor 42c, and the secondary heating resistor 42d. As a result, a temperature distribution is formed on a detection surface due to heat generated by the heating resistor 40.

As illustrated in FIG. 1, the X-axis temperature detectors 31a and 31b, the Y-axis temperature detectors 32a and 32b, the heating resistor 40, the fixed resistors 50a-50d, the pads 60a-60p, and the wires 71-78, 81-86, and 91-96 form a pattern that is substantially symmetrical with respect to the X axis and the Y axis.

### [Temperature Distribution]

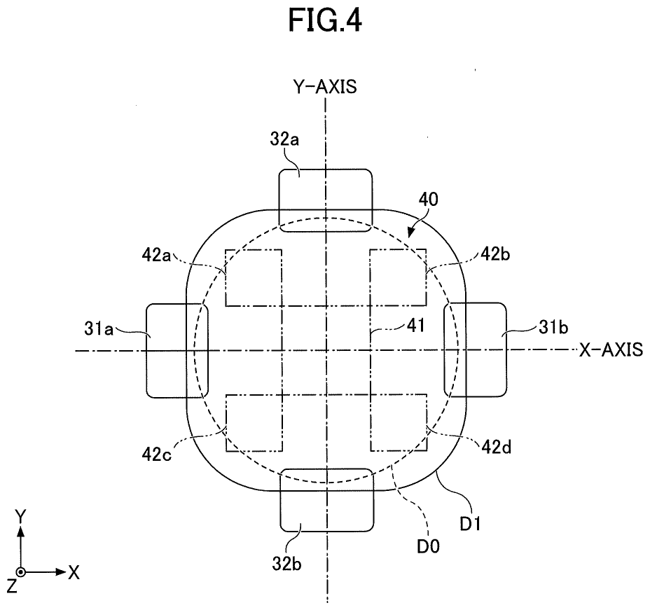

Next, a temperature distribution of heat generated by the heating resistor 40 of the present embodiment is described. FIG. 4 is a drawing illustrating an example of a temperature distribution when the flow rate is zero. In FIG. 4, a temperature distribution D1 indicates the shape of a temperature distribution formed by the heating resistor 40 of the present embodiment. A temperature distribution D0 indicates the shape of a temperature distribution formed when the secondary heating resistors 42a-42d are not provided and only the primary heating resistor 41 is provided. Thus, while the related-art temperature distribution D0 has a substantially circular shape, the temperature distribution D1 in the present embodiment has a substantially square shape.

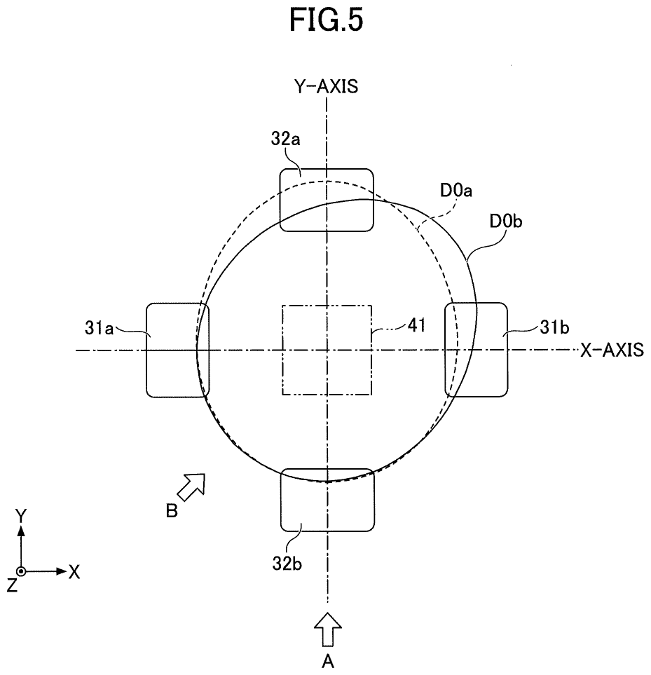

FIG. 5 is a drawing illustrating an example where a related-art temperature distribution changes depending on the flow of a fluid. In FIG. 5, a first temperature distribution D0a is formed when the flow direction is parallel to the Y-axis direction (arrow A). A second temperature distribution D0b is formed when the flow direction is at an angle of 45 degrees with each of the X-axis direction and the Y-axis direction (arrow B).

Thus, in the related-art example, the temperature distribution D0 has a substantially circular shape when the flow rate is zero, and when the flow rate is not zero, the shape of the temperature distribution D0 rotates in a direction corresponding to the flow direction. Accordingly, with the first temperature distribution D0a, the temperature difference between the Y-axis temperature detectors 32a and 32b becomes large, and the second sensor output signal increases. With the second temperature distribution D0b, the temperature difference between the Y-axis temperature detectors 32a and 32b decreases, and the second sensor output signal decreases; and the temperature difference between the X-axis temperature detectors 31a and 31b increases, and the first sensor output signal increases. In the related-art example, the temperature difference between each pair of the X-axis temperature detectors 31a and 31b and the Y-axis temperature detectors 32a and 32b, which results from the change from the first temperature distribution D0a to the second temperature distribution D0b, is small. Therefore, both of the first sensor output signal and the second sensor output signal are small, and the detection sensitivity is low.

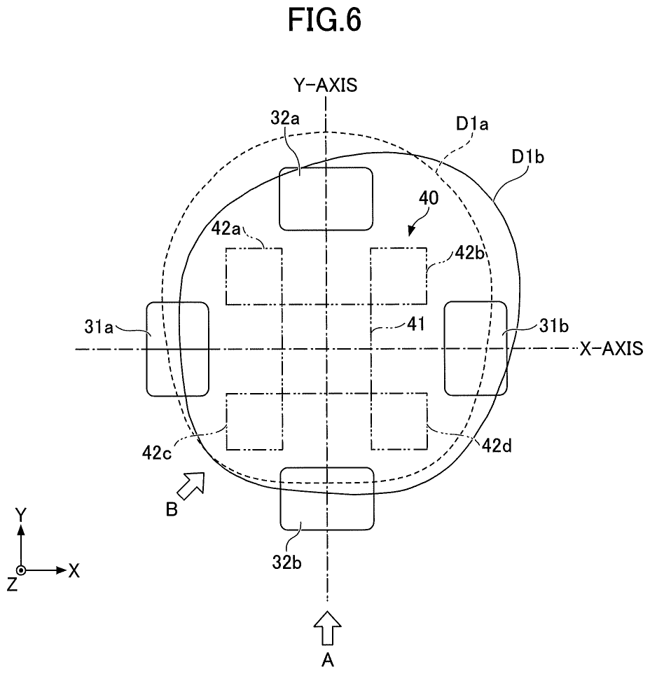

FIG. 6 is a drawing illustrating an example where a temperature distribution according to the present embodiment changes depending on the flow of a fluid. In FIG. 6, a first temperature distribution D1a is formed when the flow direction is parallel to the Y-axis direction (arrow A). A second temperature distribution D1b is formed when the flow direction is at an angle of 45 degrees with each of the X-axis direction and the Y-axis direction (arrow B).

In the present embodiment, because the temperature distribution D1 has a substantially square shape instead of a circular shape when the flow rate is zero, the temperature distribution D1 takes a shape formed by stretching a part of the square in a direction corresponding to the flow direction when the flow rate is not zero. Similarly to the related-art example, with the first temperature distribution D1a, the temperature difference between the Y-axis temperature detectors 32a and 32b is large, and the second sensor output signal increases. With the second temperature distribution D1b, the temperature difference between the Y-axis temperature detectors 32a and 32b decreases, and the second sensor output signal decreases; and the temperature difference between the X-axis temperature detectors 31a and 31b increases, and the first sensor output signal increases.

In the present embodiment, however, the temperature difference between each pair of the X-axis temperature detectors 31a and 31b and the Y-axis temperature detector 32a and 32b, which results from the change from the first temperature distribution D1a to the second temperature distribution D1b, is large. Accordingly, both of the first sensor output signal and the second sensor output signal increase, and the detection sensitivity is improved.

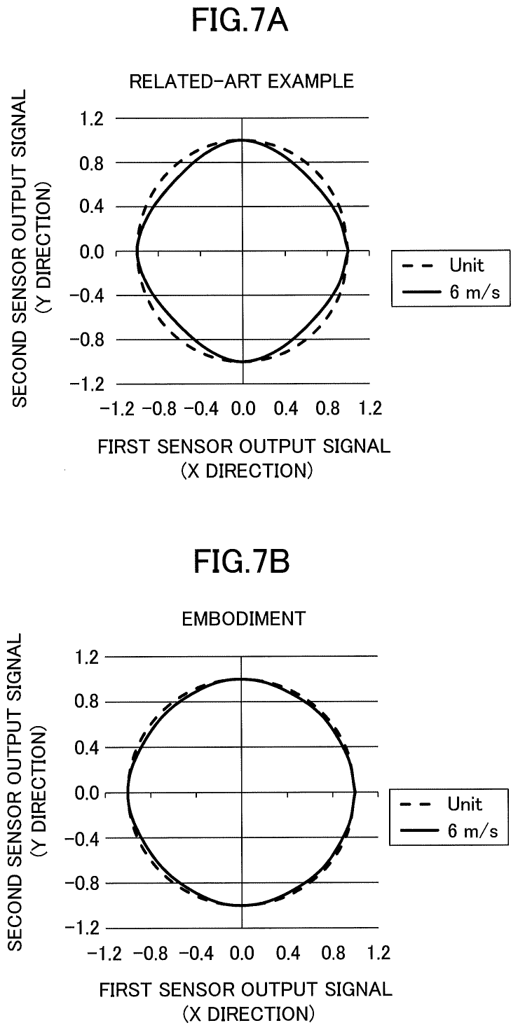

FIG. 7A is a graph illustrating the relationship between the first sensor output signal and the second sensor output signal in the related-art example. FIG. 7B is a graph illustrating the relationship between the first sensor output signal and the second sensor output signal in the present embodiment. In each of FIG. 7A and FIG. 7B, a dotted line indicates values (ideal values) of the first sensor output signal and the second sensor output signal in an ideal state where the detection sensitivity is not decreased. A solid line indicates simulation values that are obtained when the flow rate is set at 6 m/s, and are normalized by the ideal values.

As illustrated in FIG. 7A, in the conventional example, when the flow direction forms an angle of 45 degrees with each of the X-axis direction and the Y-axis direction, the detection sensitivity is greatly reduced. In contrast, as illustrated in FIG. 7B, in the present embodiment, the values of the first sensor output signal and the second sensor output signal are close to the ideal values, and the decrease in the detection sensitivity is suppressed. Thus, the present embodiment makes it possible to improve the accuracy of detecting the flow direction and the flow rate.

Next, variations of the present embodiment are described.

### <First Variation>

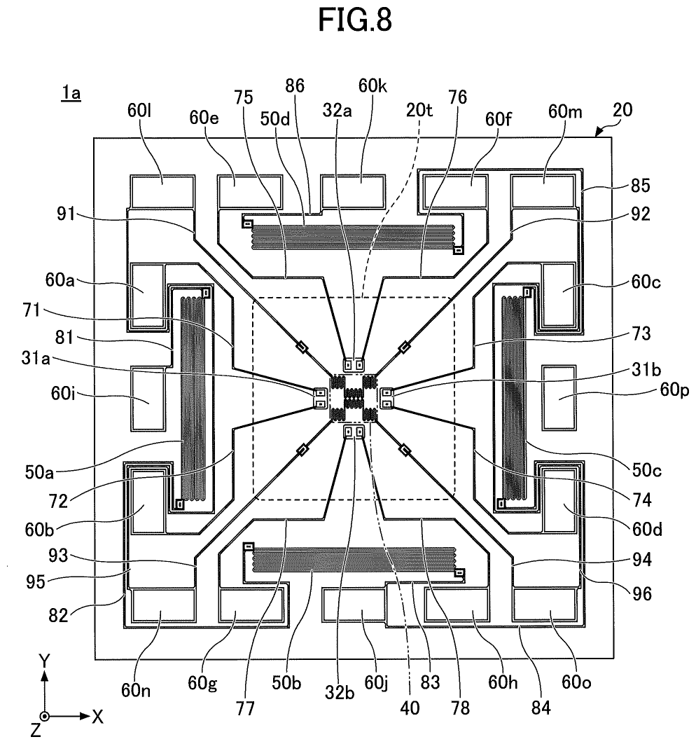

FIG. 8 is a plan view exemplifying a structure of a fluid sensor 1a according to a first variation. The fluid sensor 1a according to the first variation is different from the fluid sensor 1 of the first embodiment in that the membrane 20t has a substantially square shape in plan view. Other configurations of the fluid sensor 1a are substantially the same as those of the fluid sensor 1 of the first embodiment. Thus, the planar shape of the membrane 20t is not limited to a circular shape, but may also be a square shape.

### <Second Variation>

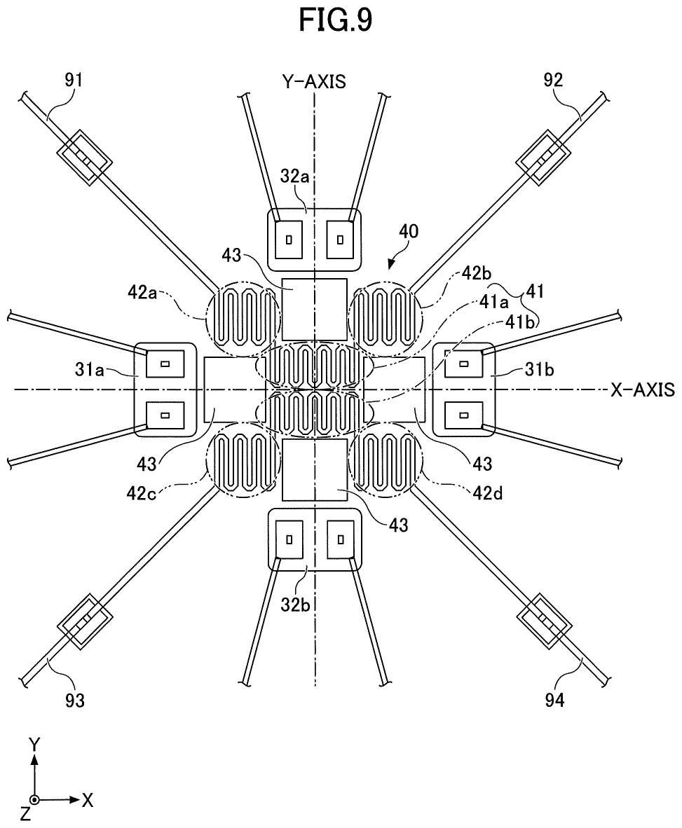

FIG. 9 is an enlarged view of a portion around the heating resistor 40 of a fluid sensor according to a second variation. In the second variation, slits 43 are provided around the primary heating resistor 41 at positions between the secondary heating resistor 42a and the secondary heating resistor 42b, between the secondary heating resistor 42b and the secondary heating resistor 42d, between the secondary heating resistor 42d and the secondary heating resistor 42c, and between the secondary heating resistor 42c and the secondary heating resistor 42a. In the area of each slit 43, the multilayer structure 20 is removed. Other configurations of the fluid sensor are substantially the same as those of the fluid sensor 1 of the first embodiment.

### <Third Variation>

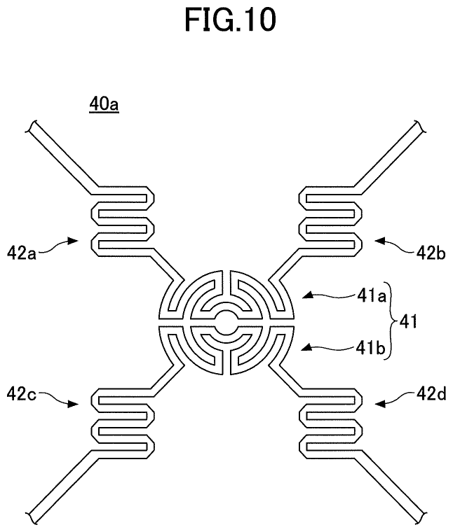

FIG. 10 is an enlarged view of a heating resistor 40a of a fluid sensor according to a third variation. The heating resistor 40a according to the third variation differs from the heating resistor 40 of the first embodiment in the shapes of the first heating resistor 41a and the second heating resistor 41b included in the primary heating resistor 41 and the shapes of the secondary heating resistors 42a-42d. In the third variation, the primary heating resistor 41 has a multiple-ring shape as a whole.

### <Fourth Variation>

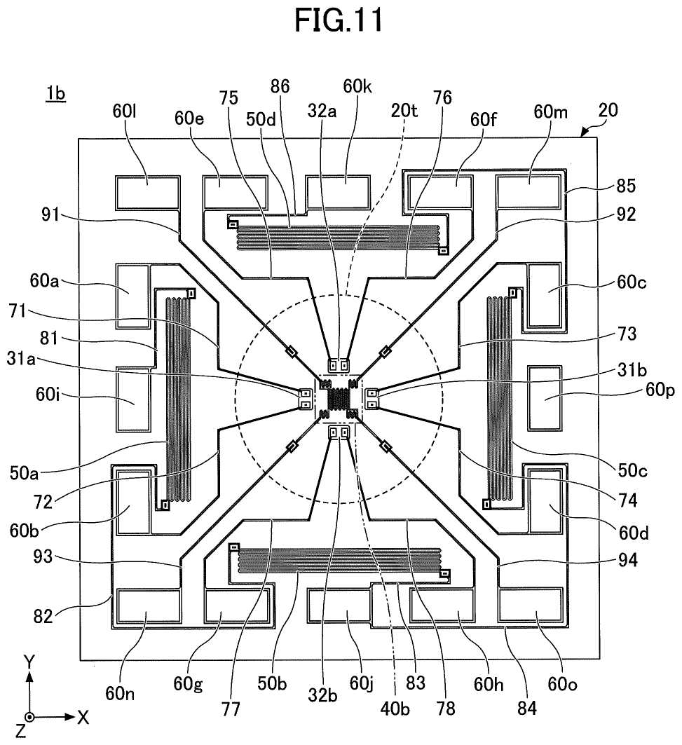

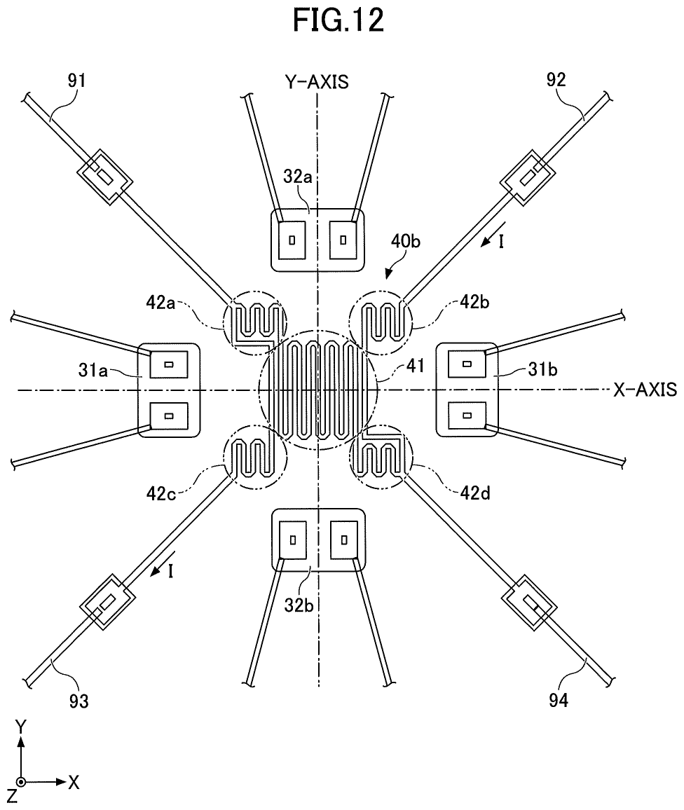

FIG. 11 is a plan view exemplifying a structure of a fluid sensor 1b according to a fourth variation. FIG. 12 is an enlarged view of a portion around a heating resistor 40b of the fluid sensor 1b according to the fourth variation. As illustrated in FIG. 12, unlike the heating resistor 40 according to the first embodiment, the primary heating resistor 41 included in the heating resistor 40b of the fourth variation is not divided, and has a meander structure as a whole. Accordingly, in the fourth variation, all of the primary heating resistor 41 and the secondary heating resistors 42a-42d are formed by bending one wire.

Also in the fourth variation, as illustrated in FIG. 11, the wire 95 for connecting the pad 601 and the pad 60n and the wire 96 for connecting the pad 60m and the pad 60o are not provided. In the fourth variation, no voltage is applied to the pad 601 and the pad 60o used as dummy pads, and a potential difference is applied between the pad 60m and the pad 60n to cause an electric current to flow through the heating resistor 40b. For example, a power supply voltage is applied to the pad 60m and the pad 60n is set at the ground potential so that, as indicated by arrows, an electric current flows through the secondary heating resistor 42b, the secondary heating resistor 42d, the primary heating resistor 41, the secondary heating resistor 42a, and the secondary heating resistor 42c in this order.

### [Materials of Temperature Detectors]

As described above, the X-axis temperature detectors 31a and 31b and the Y-axis temperature detectors 32a and 32b are preferably comprised of vanadium oxide. However, to further improve the sensitivity, a material obtained by doping vanadium oxide with aluminum (Al) and/or titanium (Ti) may be preferably used.

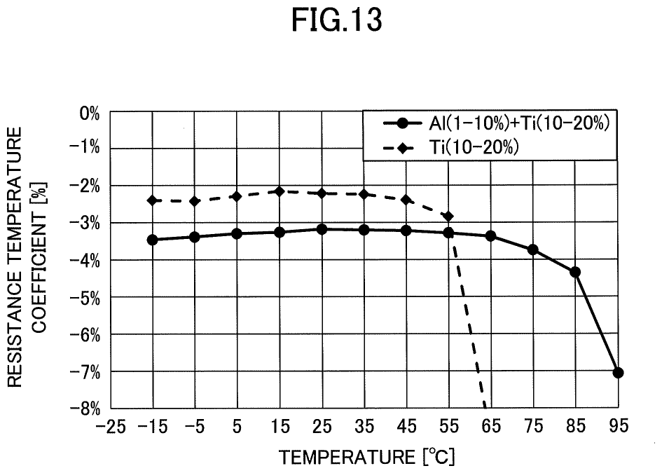

FIG. 13 is a graph illustrating a temperature characteristic of a resistance temperature coefficient of vanadium oxide. The resistance temperature coefficient indicates a percentage of change of a resistance value in relation to a temperature change.

In FIG. 13, a dotted line indicates the characteristic of vanadium oxide doped with titanium. The doping concentration of titanium is between 10% and 20%. A solid line indicates the characteristic of vanadium oxide doped with aluminum and titanium. The doping concentration of aluminum is between 1% and 10%, and the doping concentration of titanium is between 10% and 20%.

As indicated by the graph, doping vanadium oxide with aluminum and titanium increases the temperature range where the resistance temperature coefficient is constant. Accordingly, the sensitivity is improved by using vanadium oxide doped with aluminum and titanium as the material of the temperature detectors.

### [Locations of Secondary Heating Resistors]

In the above-described embodiment, the secondary heating resistor is disposed such that a line connecting the secondary heating resistor and the center of the primary heating resistor forms an angle of 45 degrees with each of the X-axis direction and the Y-axis direction. However, as long as the secondary heating resistor is disposed between the X-axis temperature detector and the Y-axis temperature detector, the secondary heating resistor is not necessarily disposed to form an angle of 45 degrees. For example, to make the temperature distribution uniform, taking into account the variation in the sensitivity of the X-axis temperature detector and the Y-axis temperature detector, the secondary heating resistor disposed between the X-axis temperature detector and the Y-axis temperature detector may be shifted toward the X-axis temperature detector or the Y-axis temperature detector.

An aspect of this disclosure makes it possible to improve the accuracy of detecting a flow direction and a flow rate.

Fluid sensors according to the embodiments of the present invention are described above. However, the present invention is not limited to the specifically disclosed embodiments, and variations and modifications may be made without departing from the scope of the present invention.

What is claimed is:

1. A fluid sensor, comprising:
a primary heating resistor;
a pair of X-axis temperature detectors disposed to face each other in an X-axis direction across the primary heating resistor;
a pair of Y-axis temperature detectors disposed to face each other in a Y-axis direction across the primary heating resistor; and
a secondary heating resistor connected to the primary heating resistor and disposed between one of the X-axis temperature detectors and one of the Y-axis temperature detectors.

2. The fluid sensor as claimed in claim 1, wherein the secondary heating resistor is disposed to form an angle of 45 degrees with each of the X-axis direction and the Y-axis direction.

3. The fluid sensor as claimed in claim 2, wherein the secondary heating resistor includes four secondary heating resistors that are symmetrical with respect to the X axis and the Y axis.

4. The fluid sensor as claimed in claim 1, wherein the secondary heating resistor has a meander structure.

5. The fluid sensor as claimed in claim 1, wherein
the primary heating resistor is divided into a first heating resistor and a second heating resistor;
the secondary heating resistor includes four secondary heating resistors;
two of the four secondary heating resistors are connected to the first heating resistor; and
other two of the four secondary heating resistors are connected to the second heating resistor.

6. The fluid sensor as claimed in claim 5, wherein each of the first heating resistor and the second heating resistor has a meander structure.

7. The fluid sensor as claimed in claim 1, wherein the X-axis temperature detectors and the Y-axis temperature detectors are formed of vanadium oxide doped with aluminum and titanium.

8. The fluid sensor as claimed in claim 7, wherein a doping concentration of aluminum is between 1% and 10%, and a doping concentration of titanium is between 10% and 20%.

9. A fluid sensor, comprising:
a heating resistor;
a pair of X-axis temperature detectors disposed to face each other in an X-axis direction across the heating resistor; and
a pair of Y-axis temperature detectors disposed to face each other in a Y-axis direction across the heating resistor,
wherein the heating resistor is divided into a first heating resistor and a second heating resistor.

10. The fluid sensor as claimed in claim 9, wherein the first heating resistor and the second heating resistor are symmetrical with respect to the X-axis direction or the Y-axis direction.

11. The fluid sensor as claimed in claim 9, wherein each of the first heating resistor and the second heating resistor has a meander structure formed by bending one wire.

12. The fluid sensor as claimed in claim 9, wherein the X-axis temperature detectors and the Y-axis temperature detectors are formed of vanadium oxide doped with aluminum and titanium.

13. The fluid sensor as claimed in claim 12, wherein a doping concentration of aluminum is between 1% and 10%, and a doping concentration of titanium is between 10% and 20%.
